(19) United States
(12) Patent Application Publication
(10) Pub. No.: US 2026/0161329 A1
(43) Pub. Date: Jun. 11, 2026

(54) STORAGE MANAGEMENT SYSTEM AND STORAGE MANAGEMENT METHOD

(71) Applicant: Hitachi Vantara, Ltd., Yokohama-shi (JP)

(72) Inventor: Tsukasa SHIBAYAMA, Tokyo (JP)

(21) Appl. No.: 19/316,916

(22) Filed: Sep. 2, 2025

(30) Foreign Application Priority Data
Dec. 9, 2024 (JP) 2024-214310

(51) Int. Cl. G06F 3/06

(52) U.S. Cl. CPC G06F 3/0665; G06F 3/0604; G06F 3/0673

(57) ABSTRACT

It is possible to alter an environment before and after transition and determine an appropriate allocation of virtual volumes. Each of a plurality of storage devices creates a virtual volume and provides the virtual volume to a host and holds a protocol endpoint as an access destination of a virtual volume and a storage container as a generation origin of a virtual volume. When a plurality of virtual volumes is caused to make a transition from a plurality of storage devices of transition origin to a plurality of storage devices of transition destination, a processor, based on a capacity and a load of each of the virtual volume groups, determines a storage device as transition destination to which a plurality of virtual volumes of a virtual volume group is caused to collectively make a transition for each of a plurality of virtual volume groups and causes the transition.

### CROSS-REFERENCE TO RELATED APPLICATION

The present application claims priority from Japanese application JP 2024-214310, filed on Dec. 9, 2024, the content of which is hereby incorporated by reference into this application.

### BACKGROUND

The present invention relates to a storage management system and a storage management method.

To cause virtual volumes (VVOL) to make a transition, a technology described in Japanese Unexamined Patent Application Publication No. 2021-114213. This publication describes that “a storage-based transition is implemented in a VVOL environment” and that “a transition processing unit 103 creates a transition group in which a virtual volume as a transition target, a protocol endpoint related to the virtual volume, and a storage container that extracts the virtual volume are grouped and causes the transition group to make a transition to a storage node 201; and a configuration alteration unit 208 configures a protocol endpoint, a virtual volume, and a storage container identical with a protocol end point, virtual volume, and storage container configured at a storage node 101 on the storage node 201 based on information of a transition group sent from the storage node 101.”

### SUMMARY

The above-mentioned conventional technology is on assumption that the environment of a storage of transition origin and the environment of a storage of transition destination are identical with each other.

Consequently, it is an object of the present invention to make it possible to alter an environment between before and after transition and to determine an appropriate allocation of virtual volumes.

Further, it is an object of the present invention to avoid load concentration by an appropriate allocation of virtual volumes.

To achieve the above-mentioned object, one of typical storage management systems of the present invention is characterized in that: the storage management system has a processor and manages a plurality of storage devices. Each of a plurality of the storage devices creates a virtual volume and provides the virtual volume to a host. The storage device holds a protocol end point as an access destination of the virtual volume and a storage container as a generation origin of the virtual volume. When a plurality of virtual volumes are caused to make a transition from a plurality of storage devices of transition origin to a plurality of storage devices of transition destination, the processor: constitutes a virtual volume group based on a plurality of the virtual volumes; constitutes a plurality of the virtual volume groups; based on the capacity and load of each of the virtual volume groups, determines a storage device as transition destination to which a plurality of virtual volumes of the virtual volume groups is caused to collectively make a transition for each of a plurality of the virtual volume groups and causes a transition.

One of typical storage management methods of the present invention is characterized in that: the storage management method is for a storage management system that has a processor and manages a plurality of storage devices. Each of a plurality of the storage devices creates a virtual volume and provides the virtual volume to a host. The storage device holds a protocol end point as an access destination of the virtual volume and a storage container as a generation origin of the virtual volume. The storage management method includes: a step of, when a plurality of virtual volumes are caused to make a transition from a plurality of storage devices of transition origin to a plurality of storage devices of transition destination, the processor constituting a virtual volume group based on a plurality of the virtual volumes; a step of constituting a plurality of virtual volume groups; and a step of, based on the capacity and load of each of the virtual volume groups, determining a storage device as transition destination to which a plurality of virtual volumes of the virtual volume group are caused to collectively make a transition for each of a plurality of the virtual volume groups and causing a transition.

According to the present invention, an environment can be altered between before and after transition and an appropriate allocation of virtual volumes can be determined. Other problems, configurations, and effects than above will be apparent from the following description of embodiments.

### BRIEF DESCRIPTION OF THE DRAWINGS

FIG. 1 is a configuration diagram of a storage management system in a first embodiment;

FIG. 2 is a drawing explaining an example of a configuration of a storage device;

FIG. 3 is an explanatory drawing of a virtual volume;

FIG. 4 is an explanatory drawing of a memory of a storage device;

FIG. 5 is an explanatory drawing of a memory of a VM provider management server;

FIG. 6 is an explanatory drawing of a memory of a transition management server;

FIG. 7 is an explanatory drawing (#1) of tables provided in a storage device;

FIG. 8 is an explanatory drawing (#2) of a table provided in a storage device;

FIG. 9 is an explanatory drawing of tables provided in a VM provider management server;

FIG. 10 is an explanatory drawing of each table provided in a transition management server;

FIG. 11 is a flowchart illustrating a processing procedure of a storage management system;

FIG. 12 is a flowchart illustrating details of Step S102;

FIG. 13 is a flowchart illustrating details of Step S103;

FIG. 14 is a flowchart illustrating details of Step S104;

FIG. 15 is a configuration diagram of a storage management system in a second embodiment; and

FIG. 16 is a flowchart illustrating details of resource allocation computation for each VVOL group in the second embodiment.

### DETAILED DESCRIPTION

Hereafter, a description will be given to embodiments with reference to the drawings.

### First Embodiment

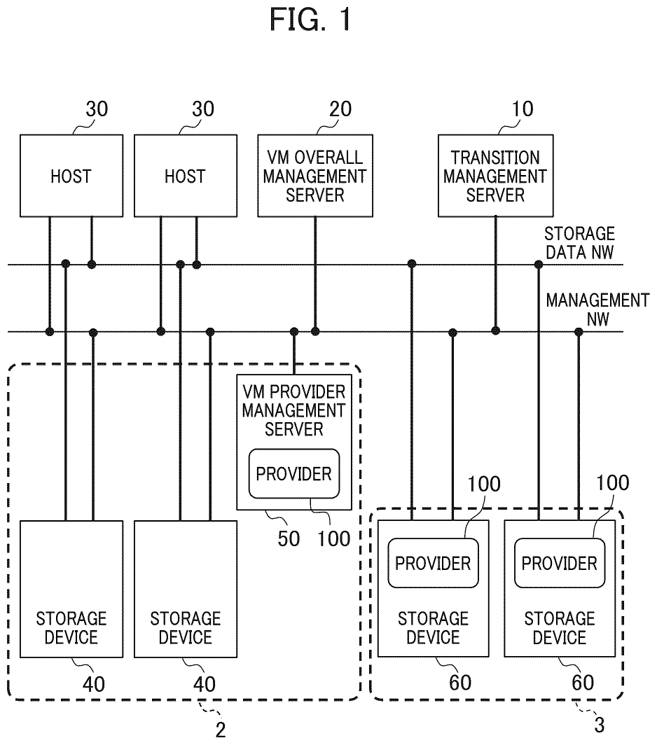

FIG. 1 is a configuration diagram of a storage management system in a first embodiment. The storage management system in the first embodiment includes a transition management server 10, a VM overall management server 20, one or more hosts 30, one or more storage devices 40, a VM provider management server 50, and one or more storage devices 60.

The host 30 is a server that operates a virtual machine (VM).

The VM overall management server 20 is a sever that manages all the VMs in the system.

The VM provider management server 50 is a server that provides a provider 100 providing a virtual volume (VVOL) function and operates as a virtual volume providing unit.

The storage device 40 and the storage device 60 are storage devices that provide a storage region to the host 30. The VM provider management server 50 and a plurality of the storage devices 40 constitute a storage system 2 as transition origin of virtual volumes. A plurality of the storage devices 60 constitutes a storage system 3 as transition destination of virtual volumes.

The transition management server 10 is a server that manages a program used when VVOL data is caused to make a transition from the storage system 2 to the storage system 3 and operates as a transition management unit. As shown in the drawing, the transition management server 10 may be standalone from other servers or may be similar to other management servers or may be present in any one storage device.

As shown in the drawing, the provider 100 may be present out of a storage device or may be present in a storage device. The provider 100 is a program that runs on a memory of the VM provider management server 50 or a storage device.

A storage data network and a management network may be identical.

Through the storage data network, IO data of user data is transmitted. Through the management network, a management command is transmitted.

The networks many be redundant. The networks may use any type of communication format and a storage service network and a backend network may be different from each other.

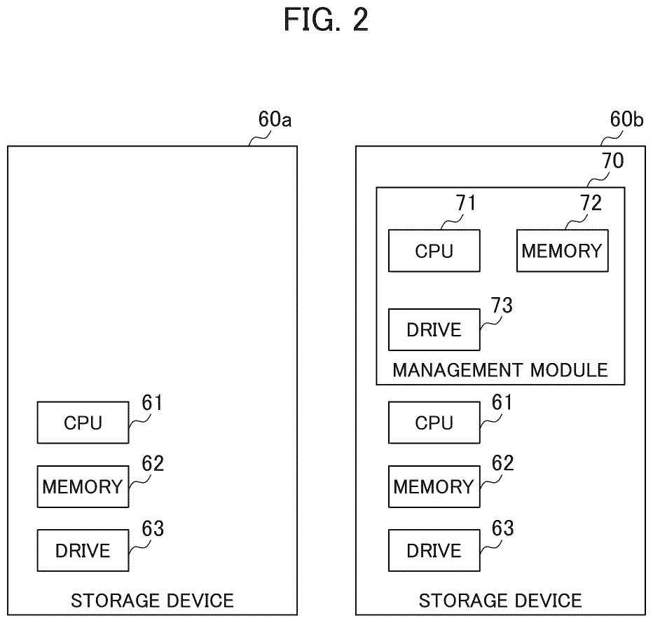

FIG. 2 is a drawing explaining an example of a configuration of a storage device.

A storage device 60a includes CPU (Central Processing Unit) 61, a memory 62, and a drive 63 and is so configured as to share a computing resource that processes input/output (I/O) commands for user data and processes commands for management operation. In the drawing, only one CPU, memory, and drive are depicted but a plurality of them may be present.

A storage device 60b includes a management module 70 aside from the CPU 61, the memory 62, and the drive 63 that process input/output (I/O) commands for user data on the storage device main body side. The management module 70 includes a computing resource (CPU 71, memory 72, drive 73) that process processing commands for management operation. That is, the storage device 60b is so configured that a computing resource that processes input/output (I/O) commands for user data and a computing resource that processes commands for management operation are separated from each other. Without physically separating the management module, the storage device may be so configured that though they are physically common, a computing resource that processes input/output commands for user data and a computing resource that processes processing commands for management operation are logically separated from each other. When the provider 100 is built in a storage device, the provider 100 utilizes the CPU, memory, and drive of the management module 70. Or, the provider utilizes CPU, a memory, and a drive logically allocated to processing commands for management operation.

In the description of the present embodiment, a configuration in which the management module is physically separated will be taken as an example but any other configuration may also be acceptable. In the present embodiment, a storage device as transition origin has a management module and does not have a built-in provider 100 and one provider 100 manages a plurality of storage devices. In the present embodiment, further, a storage device as transition destination includes a management module and has a built-in provider 100 and one in-device provider manages one storage device.

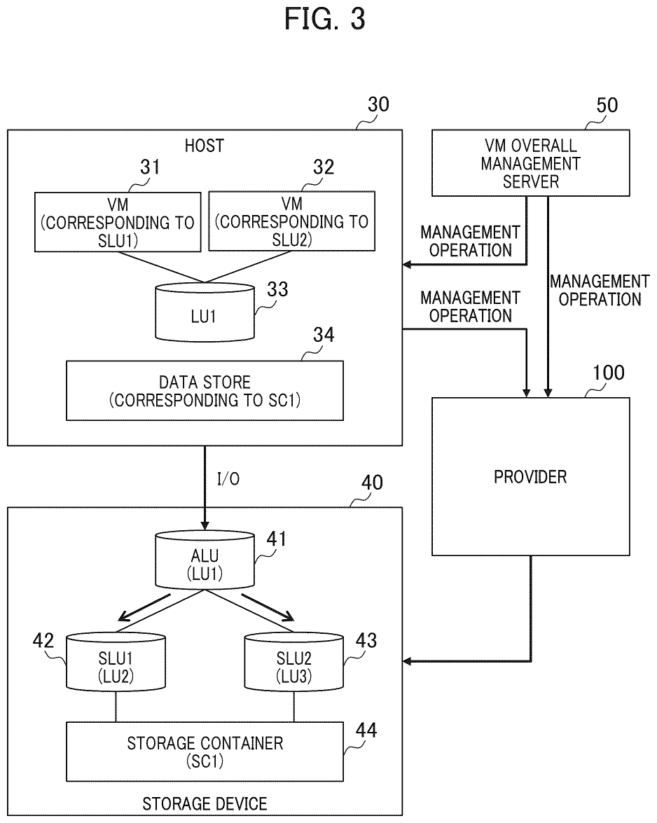

FIG. 3 is an explanatory drawing of a virtual volume. The host 30 runs a virtual machine 31 and a virtual machine 32. The virtual machine 31 and the virtual machine 32 access a logical unit 33. A data store 34 is a storage region as viewed from the virtual machine 31 and the virtual machine 32.

In case of Conglomerate SCSI (Small Computer System Interface), at the storage device 40, one or more SLU (Subsidiary Logical Unit) 42 to 43 that provide a logical volume based on a physical storage device and ALU (Administrative Logical Unit) 41 that provides a receptacle for IO to the SLU 42 to 43 are created. Accesses from the host 30 are all made through the ALU 41 and the ALU 41 sorts out IOs to the ALU itself and a bound SLU. For this reason, when the host 30 makes IO (Read/Write or the like), only the ALU 41 has to be mounted. When an operation of binding the SLU 42 to 43 to the ALU 41 is performed, I/O can be issued from the ALU 41 to the SLU 42 to 43. When the SLU 42 to 43 is unbound from the ALU 41, issuance of I/O from the ALU 41 to the SLU 42 to 43 is prohibited. When the host recognizes relation between the ALU 41 and the SLU 42 to 43 (the ALU 41 is made correspond to the logical unit 33), IO to the ALU 41 recognized on the storage side is transferred to an appropriate SLU. The ALU 41 is a protocol end point and the SLU 42 to 42 are a virtual volume. With respect to a mass of capacity (collection of pools) of the storage device 40, data inputted/outputted through SLU is processed by a storage container 44. The SLU 42 to 43 is extracted by the storage container 44 in correspondence with a pool. The data store 34 as viewed from the host 30 corresponds to the storage container 44 of the storage device 40. The total capacity that can be created as VM of the host 30 is equivalent to the capacity of the data store. With respect to these management operations, management operation with ALU and SLU is performed through the provider 100. There are cases where a management operation is sent from the host 30 to the provider 100 and cases where a management operation is sent from the VM overall management server 20 to the provider 100.

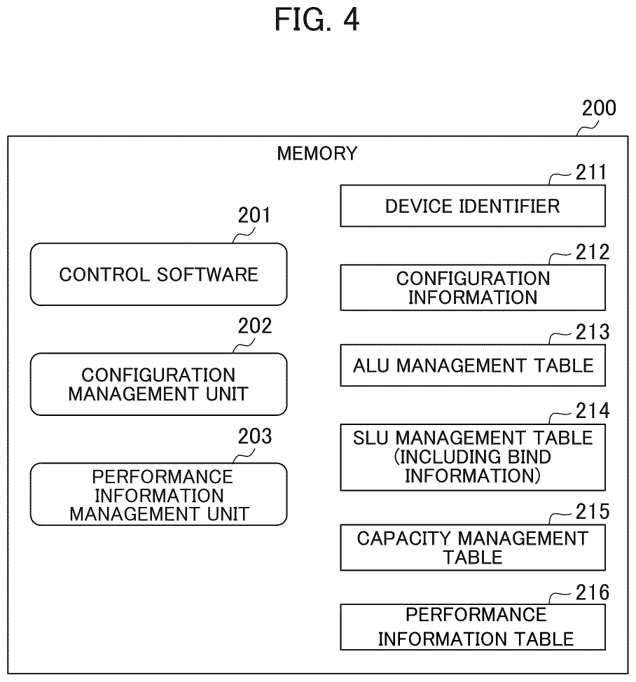

FIG. 4 is an explanatory drawing of a memory of a storage device. The memory 200 shown in FIG. 4 corresponds to a configuration in which the provider 100 is not built in. The memory 200 holds control software 201, a configuration management unit 202, and a performance information management unit 203. The memory 200 further holds a device identifier 211, configuration information 212, an ALU management table 213, an SLU management table 214, a capacity management table 215, and a performance information table 216.

The control software 201 is a program that accepts a request from the host 30 to perform I/O processing and stores data in the drive.

The configuration management unit 202 is a program that updates information of ALU or SLU under an external management operation instruction.

The performance information management unit 203 is a program that updates the performance information table 216.

The device identifier 211 has information that uniquely identifies the device. The device identifier has not only mere device identification information but also such information as device type, IP address for accessing from an external server, and the like.

The configuration information 212 contains such management information as a logical-physical conversion table required for storage control.

The ALU management table 213 indicates management information of ALU.

The SLU management table 214 indicates management information of SLU. The SLU management table 214 holds also information related to bind.

The capacity management table 215 indicates management information of a storage pool.

The performance information table 216 indicates performance information of each resource.

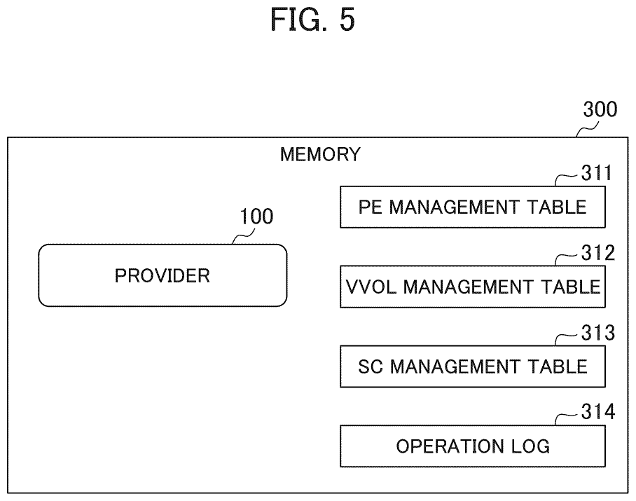

FIG. 5 is an explanatory drawing of a memory of the VM provider management server 50. A memory of a management module built in a storage device is also similar to the present memory. The memory 300 shown in FIG. 5 holds a provider 100. The memory 300 holds a PE management table 311, a VVOL management table 312, an SC management table 313, and an operation log 314.

The provider 100 is a program that accepts operation commands of VVOL and sends an instruction to a storage device.

The PE management table 311 is a table having information that makes information of the ALU management table 213 of a storage device correspond to a structure of VVOL.

The VVOL management table 312 is a table having information that makes information of the SLU management table 214 of a storage device correspond to a structure of VVOL. The VVOL management table has also information indicating correspondence between a plurality of VVOLs constituting one virtual machine.

The SC management table 313 is a table having information that makes pool information of a storage device correspond to a structure of VVOL.

The operation log 314 has operation log (history) information of operation commands of VVOL.

When the provider 100 is present in a VM provider management server 50 external to a storage device, information of various management tables corresponding to a plurality of storage devices is provided. When the provider 100 is built in a storage device, only information about the storage device having the provider built in is provided.

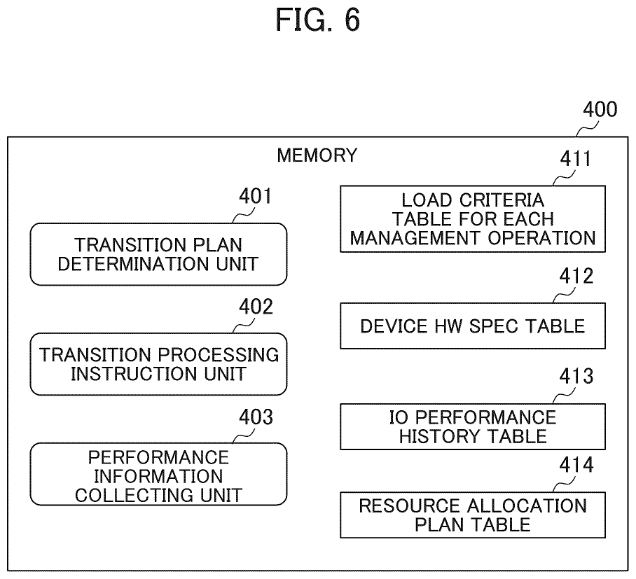

FIG. 6 is an explanatory drawing of a memory of the transition management server 10. The memory 400 shown in FIG. 6 holds a transition plan determination unit 401, a transition processing instruction unit 402, and a performance information collecting unit 403. The memory 400 further holds a load criteria table 411 for each management operation, a device hardware spec table 412, an IO performance history table 413, and a resource allocation plan table 414.

The transition plan determination unit 401 is a program that computes a logic for determining a transition plan from varied management information of each storage device and varied management information of the provider 100.

The transition processing instruction unit 402 is a program that creates an operation procedure for a storage device and VM in accordance with a plan of the transition plan determination unit 401 and performs processing of an operation procedure based on an instruction from the storage device 40, the VM overall management server 20, or the host 30.

The performance information collecting unit 403 is a program that collects performance information from each storage device.

The load criteria table 411 for each management operation is a table having information that provides a criterion of a load of a computing resource for each VVOL operation.

The device hardware spec table 412 is a table having hardware spec information of each storage device and a management module of that storage device.

The IO performance history table 413 is table holding I/O performance history information obtained by collecting performance information of each storage device.

The resource allocation plan table 414 is a table indicating a resource allocation plan.

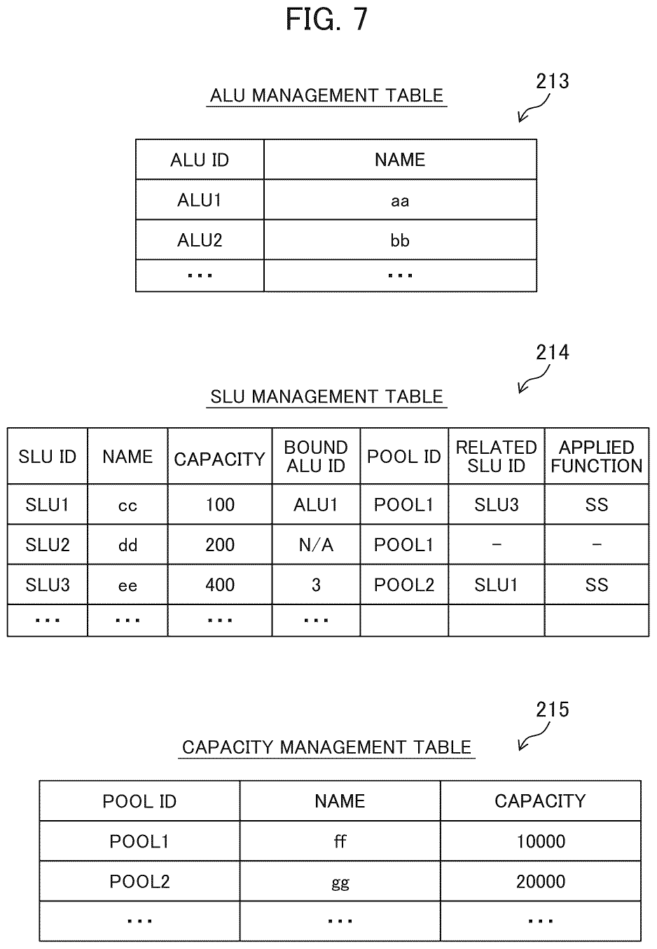

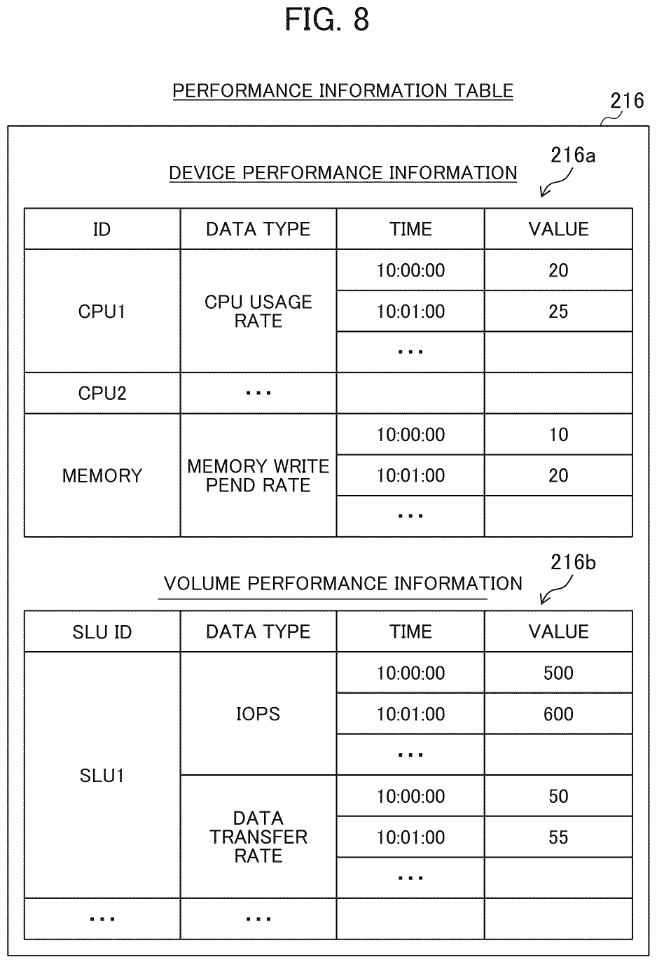

FIG. 7 and FIG. 8 are explanatory drawings of tables provided in a storage device.

The ALU management table 213 is so configured that “name” is associated with “ALU ID.”

The SLU management table 214 is so configured that “name,” “capacity,” “bound ALU ID,” “Pool ID,” “related SLU ID,” and “applied function” are associated with “SLU ID.” “Related SLU ID” indicates SLU ID of a logical unit that is standalone as a single VVOL but is related in a storage device by a function (local copy function, snapshot function, remote copy function, or the like) within the storage device. Applied function indicates which function (local copy (LC), snapshot (SS), remote copy (RC), or the like) a related SLU is using. In case of remote copy, information containing a device identifier of a destination storage is provided.

The capacity management table 215 is so configured that “name” and “capacity” are associated with “Pool ID.”

The performance information table 216 contains device performance information 216a and volume performance information 216b.

The device performance information 216a is so configured that “data type,” “time,” and “value” are associated with “ID” identifying such a computing resource as CPU, a memory, or the like. Examples of data type are CPU usage rate, memory write pend rate, and the like.

The volume performance information 216b is so configured that “data type,” “time,” and “value” are associated with “SLU ID.” Examples of data type are IOPS (Input/Output Per Second), data transfer rate, and the like.

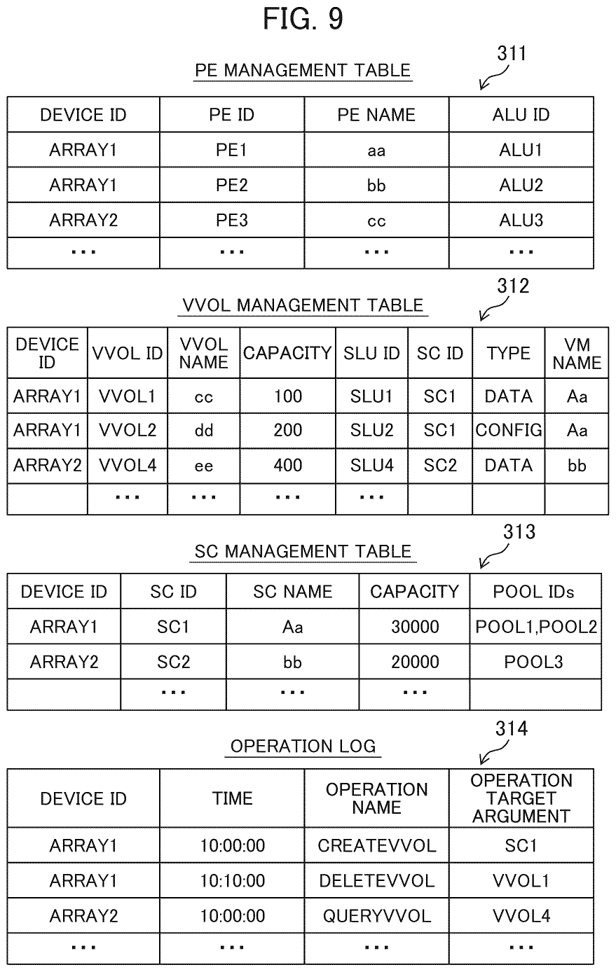

FIG. 9 is explanatory drawings of tables provided in the VM provider management server 50 (or a management module 70 when built in a storage device). As shown in FIG. 4, device ID is a device identifier provided for each device.

The PE management table 311 corresponds to the ALU management table 213. The PE management table 311 contains items of “device ID,” “PE ID” which is identification information of a protocol endpoint (PE), “PE name” which is a name of a protocol endpoint, and “ALU ID.”

The VVOL management table 312 corresponds to the SLU management table 214. Since one VVOL may correspond to a plurality of VMs sometime, the VVOL is discriminated by VM name. VVOLs that are identical in VM name and must be allocated in an identical device because of an applied function constituting the VVOLs will be hereafter referred to as VVOL group. The VVOL management table 312 contains items of “device ID,” “VVOL ID,” “VVOL name,” “capacity,” “SLU ID,” “SC (Storage Container) ID,” “Type,” and “VM name.”

The SC management table 313 corresponds to the capacity management table 215. However, one SC (storage container) corresponds to a plurality of Pools. When built in a storage device, information of device ID is all identical or omitted. The SC management table 313 contains items of “device ID,” “SC ID,” “SC name,” “capacity,” and “Pool IDs.”

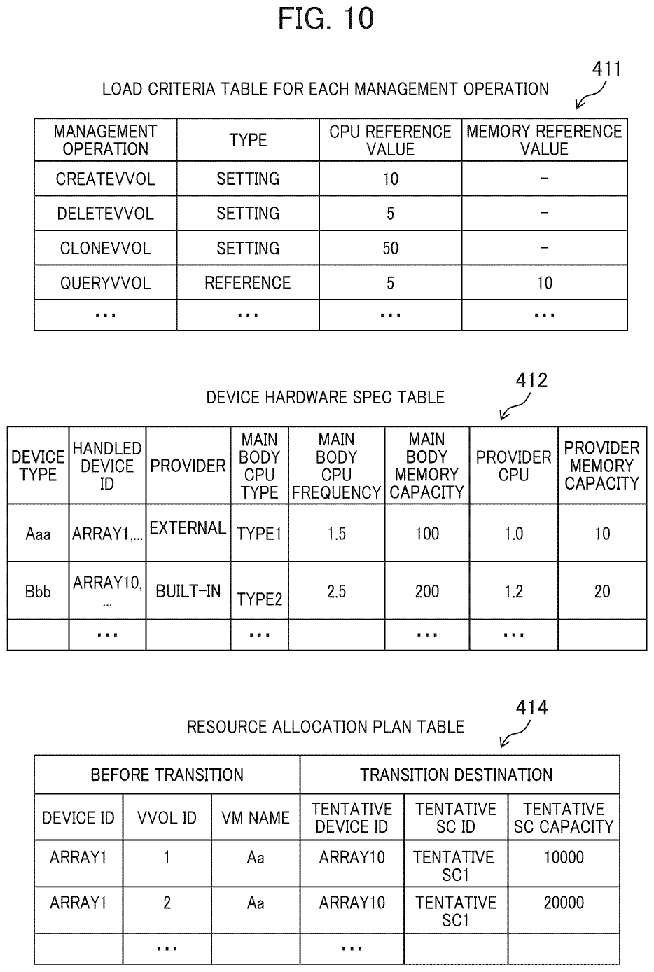

FIG. 10 is an explanatory drawing of each table provided in the transition management server 10. The IO performance history table 413 omitted from the drawing is a table obtained by adding a device ID as device identifier to a performance information table of each storage device.

The load criteria table 411 for each management operation indicates load criteria information of each management operation. The load criteria table 411 for each management operation contains items of “management operation,” “type,” “CPU reference value,” and “memory reference value.” Examples of “management operation” are “createVVOL,” “deleteVVOL,” “cloneVVOL,” “queryVVOL,” and the like. “Setting” of “type” indicates configuration alteration operation. “Reference” of “type” indicates information acquisition operation. “CPU reference value” is information indicating CPU usage rate (or workload of CPU) of an operation at CPU type and frequency that provide some basis. “Memory reference value” indicates a memory consumption required to acquire information of a unit (basically one piece) that provides some basis.

The device hardware spec table 412 indicates a spec of CPU and a memory utilized by a storage device main body of a storage device as management target and a provider (when the provider is external to a storage, a spec of the VM provider management server; and when the provider is built in a storage device, a spec of a management module). The device hardware spec table 412 contains items of “device type,” “handled device ID,” “provider,” “main body CPU type,” “main body CPU frequency,” “main body memory capacity,” “provider CPU,” and “provider memory capacity.” In the description of the present embodiment, CPU type and frequency and memory capacity are only listed for simplification but any other information may also be held for enhancement of calculation accuracy.

The resource allocation plan table 414 indicates a plan of which device and which SC should be taken as a transition destination of VM/VVOL before transition. The resource allocation plan table 414 contains items of “device ID” before transition, “VVOL ID” before transition, “VM name” before transition, “tentative device ID” of transition destination, “tentative SC ID” of transition destination, and “tentative SC capacity” of transition destination.

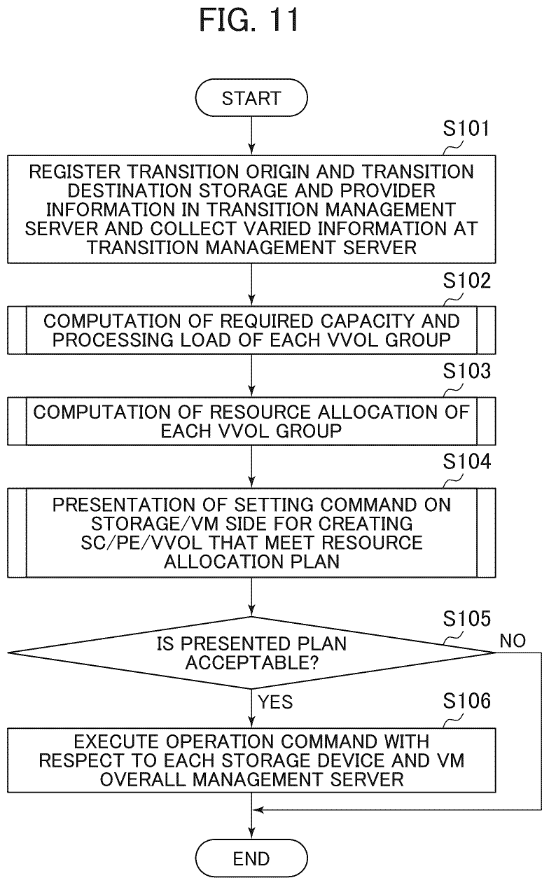

FIG. 11 is a flowchart illustrating a processing procedure of a storage management system. The transition management server 10 sequentially performs Steps S101 to S106 described below:
Step S101: The transition management server 10 accepts registration of transition origin and transition destination storages and provider information and the performance information collecting unit 403 collects varied information. Owing to this step, all the information provided in each storage device and provider becomes available to each program of the transition management server 10. Thereafter, the processing proceeds to Step S102.
Step S102: The transition plan determination unit 401 computes a required capacity and a processing load of each VVOL group. Thereafter, the processing proceeds to Step S103.
Step S103: The transition plan determination unit 401 performs resource allocation computation for each VVOL group. Thereafter, the processing proceeds to Step S104.
Step S104: The transition plan determination unit 401 creates and presents a setting command on the storage/VM side to create SC/PE/VVOL that meet the resource allocation plan. Thereafter, the processing proceeds to Step S105.
Step S105: When the transition processing instruction unit 402 accepts an input indicating that the presented plan is acceptable (S105: YES), the processing proceeds to Step S106. When an input indicating that the presented plan is acceptable is not accepted (S105: NO), the processing is terminated.
Step S106: The transition processing instruction unit 402 executes an operation command with respect to each storage device and the VM overall management server 20 and terminates the processing.

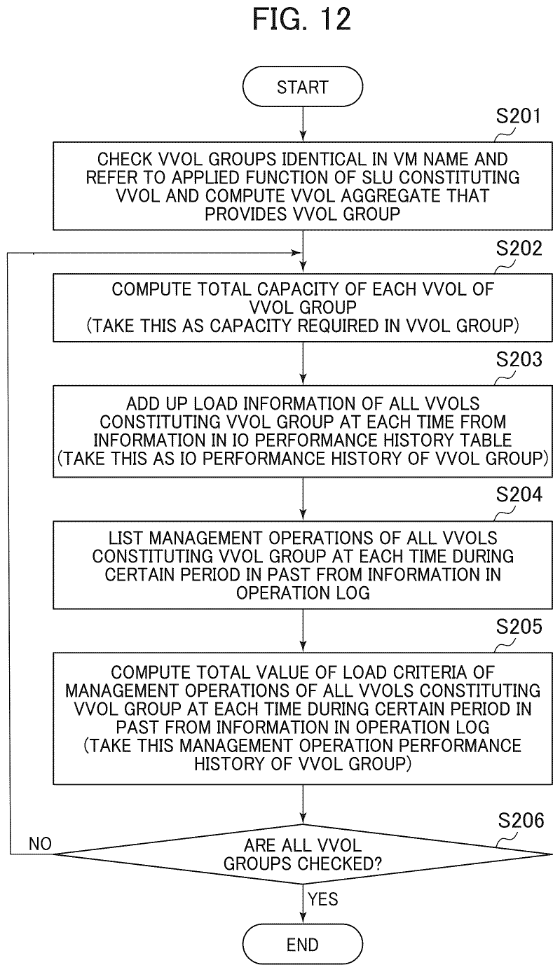

FIG. 12 is a flowchart illustrating the details of Step S102. At Step S102, the transition plan determination unit 401 sequentially performs Steps S201 to S206 described below:
Step S201: The transition plan determination unit 401 checks for VVOLs identical in VM name. Further, the transition plan determination unit references to an applied function of SLU constituting VVOL and computes a VVOL aggregation to be a VVOL group. Thereafter, the processing proceeds to Step S202.

For example, when identical in VM name, an actual data volume storing actual data and a snapshot volume storing a snapshot of an actual data volume are caused to belong to an identical group. Similarly, a virtual volume of a local copy and a setting volume storing setting information related to an actual data volume are caused to belong to the same group as actual data volumes identical in VM name. Meanwhile, with respect to a remote copy volume storing copy data by remote copy of an actual data volume, control is so exercised that the remote copy volume is prevented from belonging to the same group as actual data volumes identical in VM name and is allocated to a different storage.
Step S202: The transition plan determination unit 401 computes a total capacity of each VVOL of a VVOL group and takes the total capacity as a capacity required for the VVOL group. Thereafter, the processing proceeds to Step S203.
Step S203: The transition plan determination unit 401 adds up load information of all the VVOLs constituting the VVOL group at each time from information in the IO performance history table and takes the result of the addition as IO performance history of the VVOL group. Thereafter, the processing proceeds to Step S204.
Step S204: The transition plan determination unit 401 lists management operations of all the VVOLs constituting the VVOL group at each time during a certain period in the past from information in the operation log. Thereafter, the processing proceeds to Step S205. The certain period can be set as appropriate, for example, one day, one week, or the like. A certain period may be specified by a user input.
Step S205: The transition plan determination unit 401 computes a total value of load criteria of management operations of all the VVOLs constituting the VVOL group at each time during a certain period in the past from information in the operation log and takes the total value as management operation performance history of the VVOL group. Thereafter, the processing proceeds to Step S206.
Step S206: The transition plan determination unit 401 checks whether processing has been performed with all the VVOL groups taken as a target. When an unprocessed VVOL group remains (S206: NO), the processing returns to Step S202. When processing has been performed with all the VVOL groups taken as a target (S206: YES), the processing is terminated.

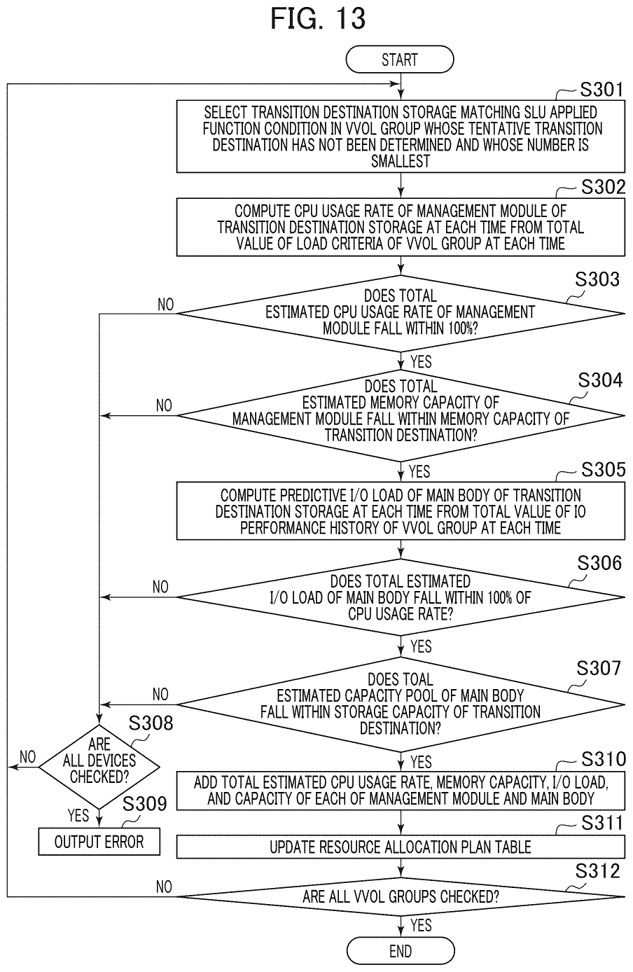

FIG. 13 is a flowchart illustrating details of Step S103. At Step S103, the transition plan determination unit 401 sequentially performs Steps S301 to S312 described below: In general, a management module has less available computing resources than a storage main body does. Consequently, in the present flowchart, a processing load of a management module is preferentially viewed. Especially, a CPU load of a management module is taken as a first basis. As processing, with a history at each time during a certain period in the past used as a reference, total values of individual VM groups are added up and allocation is computed so that the result of addition falls within a hardware upper limit. A candidate of a transition destination is selected from devices of a device ID of a young number. The present flowchart is an example of an algorithm of optimal allocation and any other algorithm may be adopted. Any algorithm is acceptable as long as an allocation with which predictive performance and capacity of a management module and a main body fall within an upper limit of a transition destination can be obtained with respect to each VVOL group.
Step S301: The transition plan determination unit 401 takes a VVOL group whose number is smallest as a processing target among VVOL groups whose tentative transition destination has not been determined and selects a transition destination storage matching an SLU applied function condition of the VVOL group as the processing target. Thereafter, the processing proceeds to Step S302.
Step S302: The transition plan determination unit 401 computes a CPU usage rate of a management module of the transition destination storage at each time from a total value of load criteria of the VVOL group at each time. Thereafter, the processing proceeds to Step S303. Specifically, a CPU usage rate of a management operation command of a management module is computed from a hardware spec on which a reference value is based and a transition destination hardware spec. Any technique can be used for calculation formula, for example, a simple ratio is used, a model formula generated from a ratio of an architecture of CPU type and a frequency is used, or the like.
Step S303: The transition plan determination unit 401 determines whether a total estimated CPU usage rate of a management module falls within 100%. When the total estimated CPU usage rate falls within 100% (S303: YES), the processing proceeds to Step S304. When the total estimated CPU usage rate does not fall within 100% (S303: NO), the processing proceeds to Step S308.
Step S304: The transition plan determination unit 401 determines whether a total estimated memory capacity of a management module falls within a memory capacity of a transition destination. When the total estimated CPU usage rate falls within 100% (S303: YES), the processing proceeds to Step S304. When the total estimated CPU usage rate does not fall within 100% (S303: NO), the processing proceeds to Step S308.
Step S305: The transition plan determination unit 401 computes a predictive I/O load of the main body of the transition destination storage at each time from a total value of IO performance history of the VVOL group at each time. Thereafter, the processing proceeds to Step S306. Like Step S304, any technique may be adopted to compute a predictive I/O load (sizing). Any technique can be used for calculation formula, for example, a simple ratio is used, computation is performed from a hardware spec and a corresponding model formula of I/O load, or the like.
Step S306: The transition plan determination unit 401 determines whether a total estimated I/O load of the main body falls within 100% of CPU usage rate. When the total estimated I/O load falls within 100% (S306: YES), the processing proceeds to Step S307. When the total estimated I/O load does not fall within 100% (S306: NO), the processing proceeds to Step S308.
Step S307: The transition plan determination unit 401 determines whether a total estimated capacity pool of the main body falls within a storage capacity of the transition destination. When the total estimated capacity pool of the main body falls within the storage capacity (S307: YES), the processing proceeds to Step S310. When the total estimated capacity pool of the main body does not fall within the storage capacity (S307: NO), the processing proceeds to Step S308.
Step S308: The transition plan determination unit 401 determines whether all the storage devices have been checked as a candidate of a transition destination. When an unchecked storage device remains (S308: NO), the processing returns to Step S301. When all the storage devices have been checked as a candidate of a transition destination (S308: YES), the processing proceeds to Step S309.
Step S309: The transition plan determination unit 401 outputs an error and terminates the processing.
Step S310: The transition plan determination unit 401 adds the total estimated CPU usage rate, memory capacity, I/O load, and capacity of each of the management module and the main body to a storage of transition destination. Thereafter, the processing proceeds to Step S311.
Step S311: The transition plan determination unit 401 updates the resource allocation plan table. Thereafter, the processing proceeds to Step S312.
Step S312: The transition plan determination unit 401 determines whether a transition destination has been checked with respect to all the VVOL groups. When an unchecked VVOL group remains (S312: NO), the processing returns to Step S301. When all the VVOL groups have been checked (S312: YES), the processing is terminated.

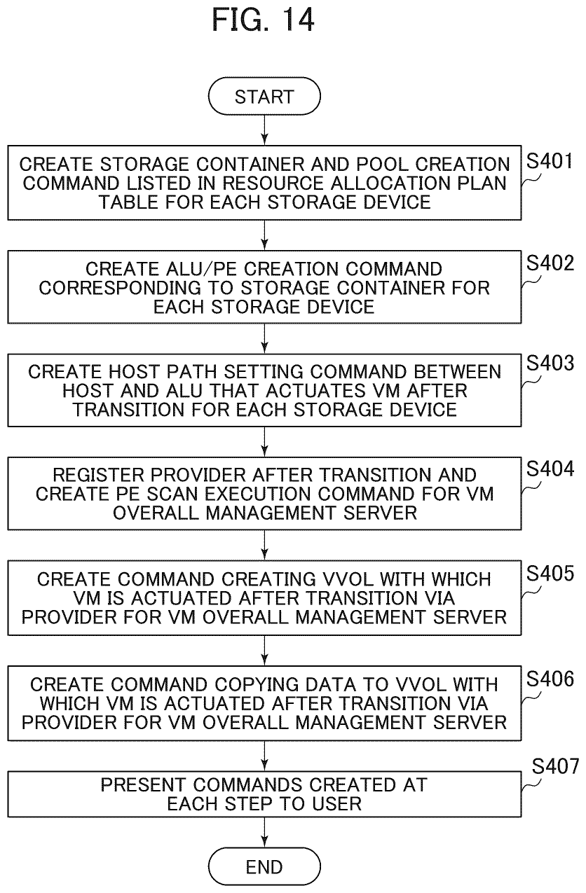

FIG. 14 is a flowchart illustrating details of Step S104. At Step S104, the transition plan determination unit 401 sequentially performs Steps S401 to S407 described below:
At Step S401, the transition plan determination unit 401 creates a storage container listed in the resource allocation plan table and a pool creation command for each storage device. Thereafter, the processing proceeds to Step S402.
Step S402: The transition plan determination unit 401 creates an ALU/PE creation command corresponding to the storage container for each storage device. Thereafter, the processing proceeds to Step S403. One ALU may be created for each storage container or one ALU may be created for a storage device and at least one corresponding ALU has to be present.
Step S403: The transition plan determination unit 401 creates a host path setting command between a host that actuates VM after transition and ALU for each storage device. Thereafter, the processing proceeds to Step S404.
Step S404: The transition plan determination unit 401 registers a provider after transition and creates a PE scan execution command for the VM overall management server. Thereafter, the processing proceeds to Step S405.
Step S405: The transition plan determination unit 401 creates a command creating VVOL with which VM is actuated after transition via a provider for the VM overall management server. Thereafter, the processing proceeds to Step S406.
Step S406: The transition plan determination unit 401 creates a command copying data to VVOL with which VM is actuated after transition via a provider for the VM overall management server. Thereafter, the processing proceeds to Step S407.
Step S407: The transition plan determination unit 401 presents the commands created at each step to a user and terminates the processing. As a presentation to a user, a command itself may be presented, or a text representing a meaning of operation by natural language may be presented, or contents of operation may be graphically presented. All the commands may be presented to a user for the user's approval or some commands may be presented for approval acceptance.

### Second Embodiment

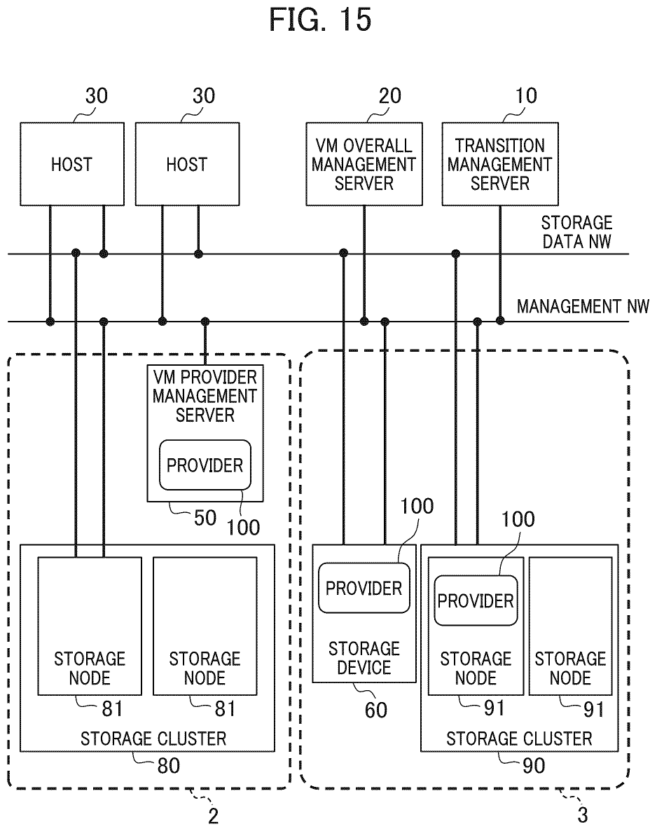

FIG. 15 is a configuration diagram of a storage management system in a second embodiment. The storage management system in the second embodiment is different from that in the first embodiment in that a storage cluster is included in a target managed by a provider of transition origin or transition destination. In the example shown in FIG. 15, the storage system 2 of transition origin is a storage cluster 80 including two storage nodes 81. The storage system of transition destination is a storage device 60 and a storage cluster 90 and the storage cluster 90 includes a plurality of storage nodes 91. One of a plurality of the storage nodes 91 is provided with a provider 100.

The storage cluster is a logical aggregate having a plurality of storage nodes in the cluster. In case of a cluster environment in which VVOL groups are allocated without straddling storage nodes and ALU/PE is created for each storage node, with IO performance taken into account, resource allocation with attention paid to storage nodes therein, rather than based on storage cluster, is important.

In the configuration of the present embodiment, it is important to allocate resources with nodes in clusters taken into account, rather than paying attention to whether providers of transition origin and transition destination are external or built in. Therefore, as an example, a case where the provider 100 managing the storage cluster 80 of transition origin is an external server and the storage cluster 90 of transition destination is a provider built in cluster. The configuration in which each storage node does not have a provider but a representative storage node is provided with a provider has been taken as an example but this does not limit the configuration of the present invention.

In the memory images shown in FIG. 9 and FIG. 10, varied information is indicated on a device ID-by-device ID basis. In the table structure of the second embodiment, each device ID is considered as a storage node and cluster ID information indicating a large storage cluster embracing a plurality of the storage nodes is provided.

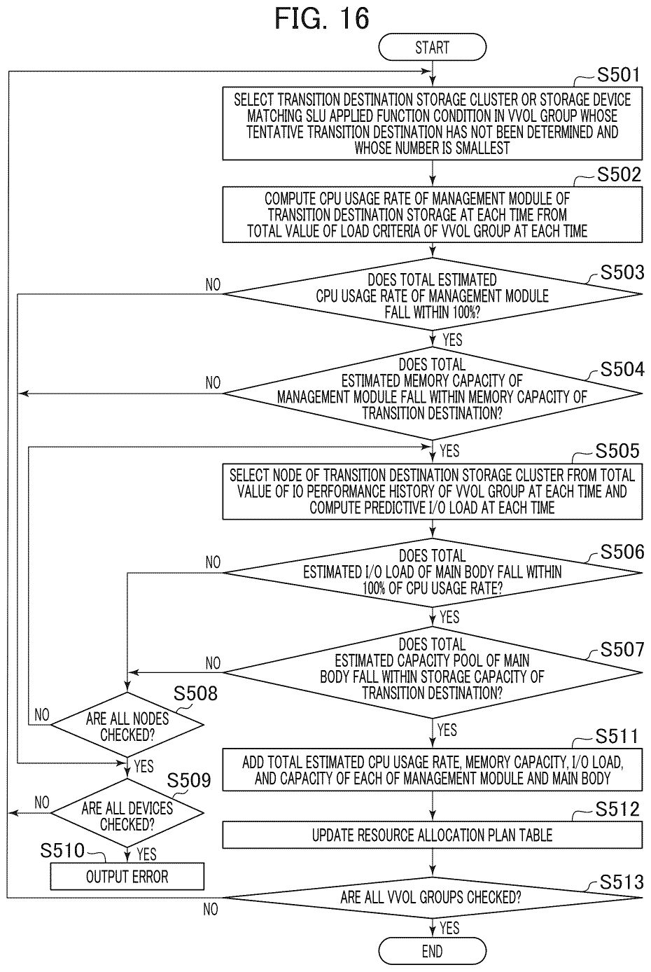

FIG. 16 is a flowchart illustrating details of resource allocation computation (Step S103) for each VVOL group in the second embodiment. At Step S103, the transition plan determination unit 401 sequentially performs Steps S501 to S513 described below:
Step S501: The transition plan determination unit 401 takes a VVOL group whose number is smallest among VVOL groups whose tentative transition destination has not been determined as a processing target and selects a transition destination storage cluster or storage device matching the SLU applied function condition of the VVOL group of the processing target. Thereafter, the processing proceeds to Step S502.
Step S502: The transition plan determination unit 401 computes a CPU usage rate of a management module of a transition destination storage at each time from a total value of load criteria of the VVOL group at each time. Thereafter, the processing proceeds to Step S503. Specifically, a CPU usage rate of a management operation command of a management module is computed from a hardware spec on which a reference value is based and a transition destination hardware spec. Any technique can be used for calculation formula, for example, a simple ratio is used, a model formula generated from a ratio of an architecture of CPU type and a frequency is used, or the like.
Step S503: The transition plan determination unit 401 determines whether a total estimated CPU usage rate of the management module falls within 100%. When the total estimated CPU usage rate falls within 100% (S503: YES), the processing proceeds to Step S504. When the total estimated CPU usage rate does not fall within 100% (S503: NO), the processing proceeds to Step S509.
Step S504: The transition plan determination unit 401 determines whether a total estimated memory capacity of the management module falls within a memory capacity of transition destination. When the total estimated CPU usage rate falls within 100% (S503: YES), the processing proceeds to Step S504. When the total estimated CPU usage rate does not fall within 100% (S503: NO), the processing proceeds to Step S509.
Step S505: The transition plan determination unit 401 selects a node of a transition destination storage cluster from a total value of IO performance history of the VVOL group at each time and computes a predictive I/O load of the main body at each time. Thereafter, the processing proceeds to Step S506. Like Step S504, any technique may be adopted to compute a predictive I/O load (sizing). Any technique can be used for calculation formula, for example, a simple ratio is used, computation is performed from a hardware spec and a corresponding model formula of I/O load, or the like.
Step S506: The transition plan determination unit 401 determines whether a total estimated I/O load of the main body falls within 100% of CPU usage rate. When the total estimated I/O load falls within 100% (S506: YES), the processing proceeds to Step S507. When the total estimated I/O load does not fall within 100% (S506: NO), the processing proceeds to Step S508.
Step S507: The transition plan determination unit 401 determines whether a total estimated capacity pool of the main body falls within a storage capacity of transition destination. When the total estimated capacity pool falls within the storage capacity (S507: YES), the processing proceeds to Step S511. When the total estimated capacity pool does not fall within the storage capacity (S507: NO), the processing proceeds to Step S508.
Step S508: The transition plan determination unit 401 determines whether all the storage nodes have been selected and checked. When an unchecked storage node remains (S508: NO), the processing returns to Step S505. When all the storage nodes have been selected and checked (S508: YES), the processing proceeds to Step S509.
Step S509: The transition plan determination unit 401 determines whether all the devices (storage devices or storage clusters) have been checked as a candidate of transition destination. When an unchecked device remains (S509: NO), the processing returns to Step S501. When all the devices have been checked as a candidate of transition destination (S509: YES), the processing proceeds to Step S510.
Step S510: The transition plan determination unit 401 outputs an error and terminates the processing.
Step S511: The transition plan determination unit 401 adds a total estimated CPU usage rate, memory capacity, I/O load, and capacity of each of the management module and the main body to the storage of transition destination. Thereafter, the processing proceeds to Step S512.
Step S512: The transition plan determination unit 401 updates the resource allocation plan table. Thereafter, the processing proceeds to Step S513.
Step S513: The transition plan determination unit 401 determines whether a transition destination has been checked with respect to all the VVOL groups. When an unchecked VVOL group remains (S513: NO), the processing returns to Step S501. When all the VVOL groups have been checked (S513: YES), the processing is terminated.

As mentioned up to this point, the storage management systems disclosed in the embodiments is a storage management system characterized in that: the storage management system has a processor and manages a plurality of storage devices. Each of a plurality of the storage devices creates a virtual volume and provides the virtual volume to a host. The storage device holds a protocol end point as an access destination of the virtual volume and a storage container as a generation origin of the virtual volume. When a plurality of virtual volumes are caused to make a transition from a plurality of storage devices of transition origin to a plurality of storage devices of transition destination, the processor: constitutes a virtual volume group based on a plurality of the virtual volumes; constitutes a plurality of the virtual volume groups; based on the capacity and load of each of the virtual volume groups, determines a storage device as transition destination to which a plurality of virtual volumes of the virtual volume groups is caused to collectively make a transition for each of a plurality of the virtual volume groups and causes a transition.

Owing to this configuration and operation, in the storage management system, an environment can be altered before and after transition and an appropriate allocation of virtual volumes can be determined.

The virtual volume group includes a plurality of the virtual volumes; a storage container and a protocol endpoint required for a transition destination of a plurality of the virtual volumes are created; and a plurality of the virtual volumes of the virtual volume group is caused to collectively make a transition to a storage device of transition destination.

At this time, a plurality of the virtual volumes of the virtual volume group is caused to make a transition to a storage device of an identical transition destination.

For this reason, a plurality of virtual volumes can be allocated to an identical storage device.

The virtual volumes are associated with a virtual machine and constitute the above-mentioned volume group based on the associated virtual machine.

For this reason, an appropriate allocation of virtual volumes can be determined on a virtual machine-by-virtual machine basis.

As an example, the virtual volume group includes a snapshot volume of the virtual volume.

For this reason, a snapshot volume can be allocated to the same storage device as a virtual volume.

As an example, a load of the virtual volume group is characterized in that a management load of the virtual volume group and a load of data input/output to a plurality of the virtual volumes are included.

For this reason, an appropriate allocation of virtual volumes can be determined with a management load of the virtual volume group and a load of data input/output to a plurality of the virtual volumes taken into account.

As an example, a storage management system computes the management load based on a management history of the virtual volume group and a load of the data input/output based on a history of data input/output to a plurality of the virtual volumes.

For this reason, a management load of the virtual volume group and a load of data input/output to a plurality of the virtual volumes can be easily obtained and an appropriate allocation of virtual volumes can be determined with these loads taken into account.

The present invention is not limited to the above-mentioned embodiments and includes various modifications. For example, the above embodiments have been described in detail for making the present invention understandable and need not always have all the configurations described above. Not only deletion of these configurations but also replacement or addition of a configuration is possible.

What is claimed is:

1. A storage management system that has a processor and
manages a plurality of storage devices,
wherein each of a plurality of the storage devices creates a virtual volume and provides the virtual volume to a host and holds a protocol endpoint as an access destination of the virtual volume and a storage container as a generation origin of the virtual volume, and
when a plurality of virtual volumes is caused to make a transition from a plurality of storage devices of transition origin to a plurality of storage devices of transition destination, the processor
constitutes a virtual volume group based on a plurality of the virtual volumes;
constitutes a plurality of the virtual volume groups; and
based on a capacity and a load of each of the virtual volume groups, determines a storage device of transition destination to which a plurality of virtual volumes of the virtual volume group are caused to collectively make a transition for each of a plurality of the virtual volume groups and causes a transition.

2. The storage management system according to claim 1,
wherein the virtual volume group includes a plurality of the virtual volumes, and
a storage container and a protocol endpoint required for a transition destination of a plurality of the virtual volumes are created and a plurality of the virtual volumes of the virtual volume group are caused to collectively make a transition to a storage device of transition destination.

3. The storage management system according to claim 2,
wherein a plurality of the virtual volumes of the virtual volume group are caused to make a transition to a storage device of an identical transition destination.

4. The storage management system according to claim 2,
wherein the virtual volume is associated with a virtual machine, and
the virtual volume group is configured based on the associated virtual machine.

5. The storage management system according to claim 2,
wherein the virtual volume group includes a snapshot volume of the virtual volume.

6. The storage management system according to claim 1,
wherein a load of the virtual volume group includes a management load of the virtual volume group and a load of data input/output to a plurality of the virtual volumes.

7. The storage management system according to claim 2,
wherein the management load is computed based on a management history of the virtual volume group and the load of data input/output is computed based on a history of the data input/output to a plurality of the virtual volumes.

8. A storage management method in a storage management system that has a processor and manages a plurality of storage devices,
wherein each of a plurality of the storage devices creates a virtual volume and provides the virtual volume to a host and holds a protocol endpoint as an access destination of the virtual volume and a storage container as a generation origin of the virtual volume,
the storage management method comprising: when a plurality of virtual volumes is caused to make a transition from a plurality of storage devices of transition origin to a plurality of storage devices of transition destination,
a step of the processor constituting a virtual volume group based on a plurality of the virtual volumes;
a step of constituting a plurality of the virtual volume groups; and
a step of, based on a capacity and a load of each of the virtual volume groups, determining a storage device of transition destination to which a plurality of virtual volumes of the virtual volume group is caused to collectively make a transition for each of a plurality of the virtual volume groups and causing a transition.
